(19) United States
(12) Patent Application Publication
(10) Pub. No.: US 2014/0202078 A1
(43) Pub. Date: Jul. 24, 2014

(54) COLLAPSIBLE PLANT CONTAINER

(71) Applicant: Jiangsu Zhongheng Pet Supplies Co., Ltd., Jiangsu (CN)

(72) Inventor: Bin QIU, Jiangsu (CN)

(73) Assignee: Jiangsu Zhongheng Pet Supplies Co., Ltd., Jiangsu (CN)

(21) Appl. No.: 14/161,085

(22) Filed: Jan. 22, 2014

(30) Foreign Application Priority Data
Jan. 19, 2013 (CN) 201320053904.1

(51) Int. Cl. A01G 9/02

(52) U.S. Cl. CPC A01G 9/02
USPC 47/79

(57) ABSTRACT

A collapsible plant container has a collapsible body in a tapered shape with corrugated body wall and a base attached to the body. The plant container further includes a water leakage passage located at the center of the base. The water storage tank is disposed outside of the water leakage passage. The water storage tank is higher than the water leakage passage.

### CROSS REFERENCE TO RELATED APPLICATION

The present application is based on, and claims priority from, Chinese Application Number 201320053904.1, filed Jan. 19, 2013, the disclosure of which is incorporated herein in its entirety.

### TECHNICAL FIELD

The present disclosure relates generally to a plant container for indoor and outdoor plants, and specifically, a collapsible plant container for preserving water and/or fertilizer and/or having a filter for increasing air permeability.

### BACKGROUND

With the accelerating pace of life and the continuous improvement of living standards, people are paying more attention to improving the quality of life and the development of their physical and mental health. In their spare time, the activities of planting flowers and greening decoration become the life enjoyment for more and more people. Planting flowers, not only can improve an air quality, beautify a living environment, but can also help people to release the pressure of their life and make self-cultivation, thus becomes an indispensable part in their daily life. Conventionally, most plant containers are made of pottery, porcelain or tile. These pots are not only fragile and heavy, but also usually occupy a large space. It is not easy to move and store these conventional plant containers, as well as requiring high transportation costs. Moreover, the containers which are made of pottery, porcelain or tile cannot preserve fertilization and water well. Especially in summer, most potted plants need to be watered every day. Thus, the plants potted in the pottery, porcelain or tile containers will wither if lacking of timely watering. In order to solve these problems, many gardening enthusiasts have made many improvements. Although some progresses have been made, they all so far do not solve these practical technology problems well.

### SUMMARY

In order to overcome one or more of the aforementioned shortcomings, one or more objects of one or more embodiments of the present disclosure is to provide a collapsible container for preserving water and/or fertilizer. The plant container is made of blow molding plastic material. The plant container includes a collapsible body. Thus, when the body is collapsed, the size of the plant container will be reduced. In this way, the plant container does not require a large space for storage. Additionally, because of the plastic material, the weight of the plant container is light and therefore the plant container can be easily moved. Accordingly, the usage of plastic material can reduce the costs of transportation and storage. The plant container further includes a water storage tank and a fertilizer storage tank at a base of the container for preserving water and fertilizer, respectively.

In an aspect, a collapsible plant container includes a top, a body, a filter, a water leakage passage, a water storage tank, a fertilizer storage tank and a base. The plant container as a whole is in a form with a top and a bottom, where the diameter (or in some embodiments, cross-sectional width) of the bottom is smaller than the diameter (or width) of the top. The body is in a tapered shape (in side view) with a corrugated body wall which is collapsible. The water leakage passage is funnel-shaped and located at the center of the bottom of the base. The water storage tank is arranged outside of the water leakage passage. The water storage tank is higher than the water leakage passage. The fertilizer storage tank is located outside of the water storage tank and higher than the water storage tank. The filter is installed on top of the fertilizer storage tank. The filter is a mesh having a shape similar to a cross-section shape of the body. A plurality of inverted U shaped vents, e.g., “∩”, is located at the base intermittently arranged along a bottom circumference of the base.

In another aspect, the plant container is made of blow molding plastic materials. Such plastic material has light weight with a low manufacturing cost. The plastic material is durable, chip-and-break resistant. The body of the container is collapsible with a high degree of collapsibility. Hence, the height of the body is adjustable corresponding to the potted plant's size and/or planting depth. In addition, during the storage or movement, the body is foldable to reduce the space and make the moving and storing much easier. The water leakage passage is located at the bottom center of the pot base for allowing extra water to flow outside of the container. The water storage tank is arranged outside of the water leakage passage and higher than the water leakage passage so that some water can be preserved in the water storage tank without flowing away through the water leakage passage and extra water which does not fit in the water storage tank can flow away through the water leakage passage. Thus, the water preserved in the water storage tank is used as a timely water supply for the potted plant when the plant is short of water. The fertilizer storage tank is arranged outside of the water storage tank. Fertilizer is stored in the fertilizer storage tank in advance in order to continuously provide nutrients to the plants, thus reduce the workload of manual fertilization and save time. The fertilizer storage tank is higher than the water storage tank. The filter is disposed on top of the fertilizer storage tank. The filter is also made of plastic material or other suitable materials. The filter prevents soil from dropping and increases the permeability for moisture and/or air. A plurality of vents is provided at the base and is intermittently arranged around the bottom circumference of the base. In addition to ventilation, the filter can also effectively prevent plant root from rotting. The body and base of the plant container are formed through a heat-pressing process to be integral with each other to define a single piece as a whole.

Several advantages are provided by one or more embodiments including the following features: the plant container is made by blow molding plastic material and the body of the container is collapsible. Therefore, such plant container needs only a small space, being light weight, and is easy to move and store. The addition of the water storage tank and the fertilizer storage tank in the container can reduce the intensity of every day work, save time, such as to meet people's need in their life.

### BRIEF DESCRIPTION OF THE DRAWINGS

The present disclosure will be further described in conjunction with drawings and embodiments. Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a side view of an embodiment of a collapsible plant container with a partial sectional view showing an inner side of the container.

FIG. 2 is an enlarged view of the partial sectional view in FIG. 1.

FIG. 3 is a top view of an embodiment of the collapsible plant container as shown in FIG. 1.

FIG. 4 is a side view of an embodiment of the collapsible plant container in a folded state thereof.

### DETAILED DESCRIPTION

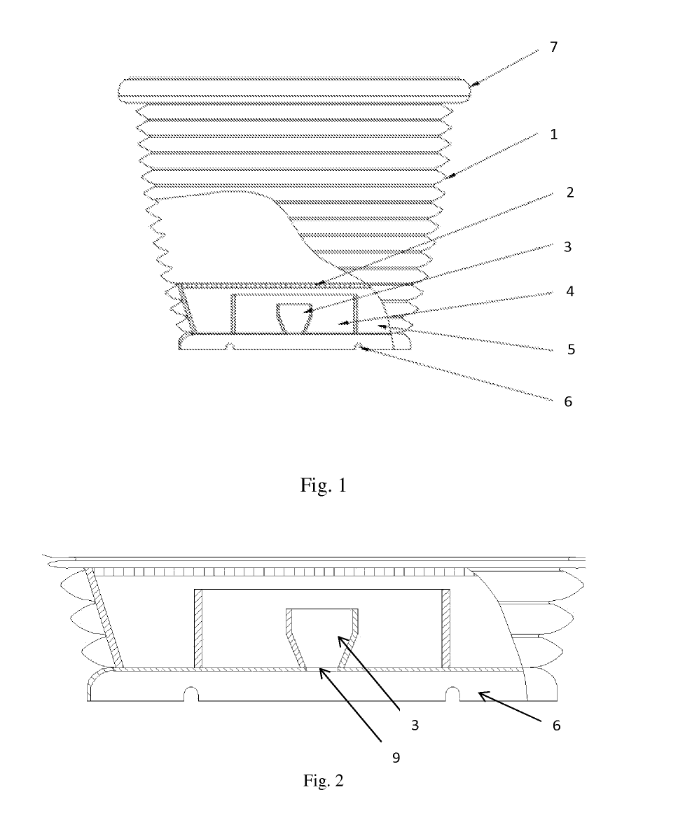

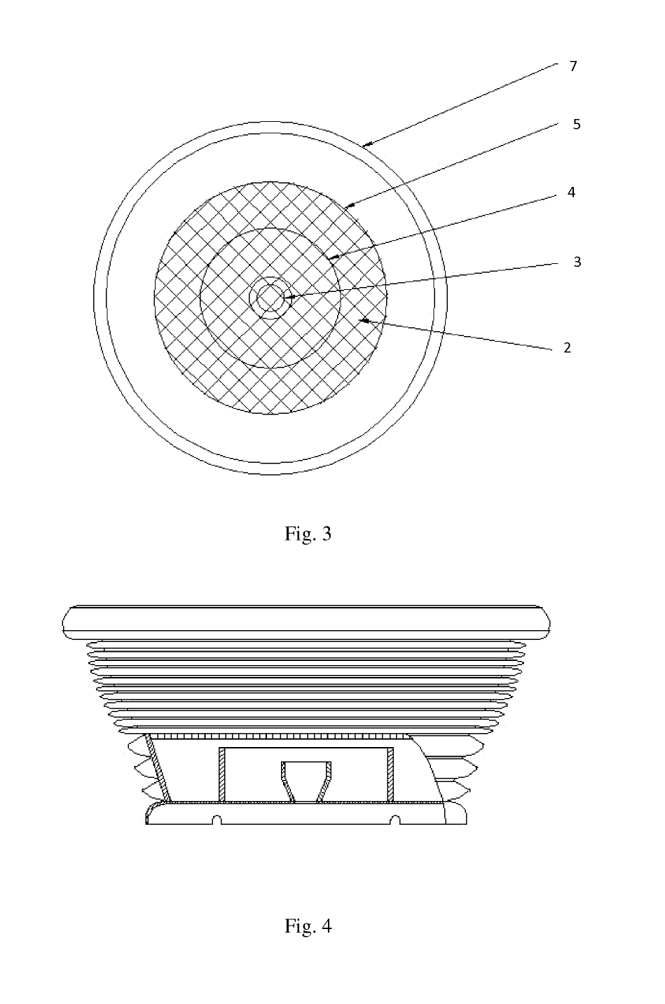

One or more embodiments of a collapsible plant container will be explained with reference to FIGS. 1, 2, 3 and 4.

In reference to FIGS. 1 and 2, the collapsible plant container as a whole is in a form with a top and a bottom, where the bottom is smaller than the top. The plant container as shown in FIGS. 1-4 is formed in a round shape as viewed from the top. In one or more embodiments, the plant container can be formed in other suitable shapes, for example, in a square shape or a polygonal shape as viewed from the top. The body 1 of the plant container in FIG. 1 is in a tapered shape (in side view) and has a corrugated body wall which is collapsible. The plant container as shown in FIG. 1 further includes a top 7 and a base 6. The body 1 is formed between the top 7 and the base 6. According to the embodiment described in FIG. 1, the top 7 has the greatest diameter of the plant container and the base 6 has the smallest diameter of the plant container.

A funnel-shaped water leakage passage 3 is arranged in the collapsible plant container. Particularly, as shown in FIGS. 1-3, the water leakage passage 3 is located on the center axis of a base 6. A water storage tank 4 is outside of the water leakage passage 3. The water storage tank 4 surrounds the water leakage passage 3. The water storage tank 4 is slightly higher than the water leakage passage 3. Specifically, as shown in FIGS. 1 and 2, a top surface of the water storage tank is higher than a top surface of the water leakage passage 3. The collapsible plant container further includes a fertilizer storage tank 5 located outside of the water storage tank 4. The fertilizer storage tank 5 is slightly higher than the water storage tank 4. Specifically, a top surface of the fertilizer storage tank 5 is higher than the top surface of the water storage tank 4.

FIG. 1 shows that the collapsible plant container further includes a filter 2 disposed on top of the fertilizer storage tank 5. The filter 2 has a shape suitable for the shape of the plant container so that the filter 2 is fixed to an inner surface of the body 1 of the plant container. A periphery of the filter 2 is in direct contact with the inner surface of the body 1. In the embodiment of FIGS. 1-3, the filter 2 is a net-shaped filter in a round form. The filter 2 can be formed of different shapes corresponding to the shape of the plant container.

Further as shown in FIG. 2, the base 6 of the plant container has a cap-shape and has an opening 9 connected to a bottom of the water leakage passage 3 so that water can flow outside of the container plant directly from the water leakage passage 3. The diameter of the opening 9 is substantially the same as the diameter of the bottom of the water leakage passage 3. The base 6 includes numerous inverted U shaped, e.g., “∩,” vents formed along a bottom circumference of the base 6.

The collapsible plant container is formed by blow molding plastic material which has a light weight. The process of blow molding requires low cost. The plastic material is durable and chip-and-break resistant. The body 1 of the plant container is collapsible with a high degree of collapsibility. Thus, the height of the body 1 is adjustable.

FIG. 4 shows an embodiment of the plant container in a folded state. The filter 2 divides the body 1 into a top portion and a bottom portion. The top portion of the body 1 is folded along the central axis of the plant container and the bottom portion of the body 1 remain unfolded. In the folded state of the plant container, the top 7 and the bottom 6 remain unfolded.

There are several advantages according to one or more embodiments of the collapsible plant containers. For example, soil used for planting can be removed from the container and then the body 1 can be folded when people want to store the container and/or move the container to another place. Therefore, such collapsible containers can help people save storage space.

Further, the water leakage passage 3 located at the center of base 6 facilitates removal of extra water hence to prevent the plant root rot issue. The water storage tank 4 is disposed outside of the water leakage passage 3 to save some water as a timely water supply for the plant when the plant is short of water. The water storage tank 4 is higher than the water leakage passage 3 for the purpose of getting rid of the excessive water through the water leakage passage 3 when the water is too much and cannot be stored in the water storage tank 4.

Further, the fertilizer storage tank 5 is formed outside of water storage tank 4. In one or more embodiments, fertilizer is pre-stored in the fertilizer storage tank 5 for continuously providing nutrients to the plants and therefore reducing the workload of manual fertilization. The fertilizer storage tank 5 is slightly higher than the water storage tank 4. Hence the filter 2 is set on top of the fertilizer storage tank 5. The filter 2 is also made of plastic material. The filter 2 is configured to prevent soil drops and increase air permeability.

Furthermore, a plurality of vents is arranged around a bottom circumference of base 6. In addition for ventilation, the vents can also effectively prevent plant root rot. The body 1 and base 6 of the plant container are made as a whole entity through a heat-pressing process.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A collapsible plant container, comprising:
a collapsible body;
a base attached to the body;
a water leakage passage in the base; and
a water storage tank located outside of the water leakage passage;
wherein
the water storage tank is higher than the water leakage passage.

2. The collapsible plant container according to claim 1, further comprising a fertilizer storage tank located outside of the water storage tank, wherein the fertilizer storage tank is higher than the water storage tank.

3. The collapsible plant container according to claim 1, wherein the body is configured to define a tapered shape of the plant container.

4. The collapsible plant container according to claim 1, wherein the body comprises a wall which is corrugated.

5. The collapsible plant container according to claim 1, wherein the water leakage passage has a funnel shape.

6. The collapsible plant container according to claim 1, further comprising a filter disposed on top of the fertilizer storage tank, wherein a periphery of the filter directly contacts an inner surface of the body.

7. The collapsible plant container according to claim 6, wherein the filter divides the body into a top portion and a bottom portion, and the top portion is collapsible.

8. The collapsible plant container according to claim 6, wherein the filter is a mesh.

9. The collapsible plant container according to claim 1, wherein the water leakage passage is arranged at a center of the base.

10. The collapsible plant container according to claim 1, wherein the body is made of blow molding plastic material.

11. The collapsible plant container according to claim 1, wherein the body and the base are integral with each other.

12. The collapsible plant container according to claim 1, wherein the fertilizer storage tank comprises soil and fertilizer.

13. The collapsible plant container according to claim 1, further comprising a plurality of vents intermittently arranged a bottom circumference of the base.

14. The collapsible plant container according to claim 13, wherein each of the vents has an inverted U shape.

15. The collapsible plant container according to claim 1, wherein the water storage tank surrounds the water leakage passage.

16. The collapsible plant container according to claim 1, wherein a wall of the water storage tank is higher than a wall of the water leakage passage.

17. The collapsible plant container according to claim 1, wherein the water storage tank and the water leakage passage are coaxially arranged.

18. A container comprising:
a collapsible body;
a base attached to the body;
a passage connected to the base;
a first storage tank located outside of the leakage passage; and
a second storage tank located outside of the first storage tank,
wherein
the first storage tank is higher than the leakage passage, and
the second storage tank is higher than the first storage tank.

19. The container according to claim 18, further comprising a filter disposed on the second storage tank and in direct contact with an inner surface of the body.

20. The container according to claim 19, wherein the filter divides the body into a top portion and a bottom portion, and the top portion is collapsible.
